(19) United States
(12) Patent Application Publication
(10) Pub. No.: US 2026/0206780 A1
(43) Pub. Date: Jul. 23, 2026

(54) Filter and Method for Removing Chemical Residue from Breast Milk

(71) Applicants: Natalie Johnson, College Station, TX (US); Timothy Phillips, College Station, TX (US); Meichen Wang, College Station, TX (US); Kaylyn Dinh, Corpus Christi, TX (US)

(72) Inventors: Natalie Johnson, College Station, TX (US); Timothy Phillips, College Station, TX (US); Meichen Wang, College Station, TX (US); Kaylyn Dinh, Corpus Christi, TX (US)

(73) Assignee: The Texas A&M University System, College Station, TX (US)

(21) Appl. No.: 19/453,234

(22) Filed: Jan. 20, 2026

Related U.S. Application Data
(60) Provisional application No. 63/747,232, filed on Jan. 20, 2025.

(51) Int. Cl. A23C 9/14; B01J 20/12; B01J 20/28

(52) U.S. Cl. CPC A23C 9/14; B01J 20/12; B01J 20/28019; B01J 20/28035

(57) ABSTRACT

Sorbent formulations are used as filters and filter composites in filtration systems to remove environmental toxins, for example, per-fluoroalkyl and poly-fluoroalkyl substances, from human breast milk and dairy milk during pumping. Filtration systems and methods for removing environmental toxins from milk, for example, from breast milk during pumping use the sorbent formulations.

### CROSS-REFERENCE TO RELATED APPLICATIONS

This non-provisional patent application claims benefit of priority under 35 U.S.C. § 119(e) of provisional application U.S. Ser. No. 63/747,232, filed Jan. 20, 2025, the entirety of which is hereby incorporated by reference.

### FEDERAL FUNDING LEGEND

This invention was made with government support under Grant Numbers P42 ES027704, T32 ES026568 and R00ES034090 awarded by the National Institute of Environmental Health Sciences. The government has certain rights in the invention.

### BACKGROUND OF THE INVENTION

### Field of the Invention

The present invention relates generally to the fields of breastfeeding and infant health and environmental toxicology. More specifically, the present invention relates to a clay filter or sorbent composite for removal of environmental toxins from breast milk.

### Description of the Related Art

Breast milk can contain a wide range of toxic chemicals reflecting maternal exposure occurring recently or even long ago, as fat-soluble chemicals may be stored in the body for years prior to mobilization through lactation. Currently, there are no available options to remove these chemicals from breast milk, even though they can negatively impact children's health.

Infancy is a time for tremendous growth and development and exposure to environmental toxins can negatively impact brain development, lung and immune function, and much more. Breastfeeding provides essential nutrition for infants and offers a variety of benefits to children, such as, it also allows for the lactational transfer of environmental chemicals to infants during critical developmental stages of life.

While the benefits of breastfeeding generally outweigh risks from chemical exposures through breastmilk, some mothers and infants may be at increased risk for exposure, for instance living in close proximity to hazardous waste sites, industrial operations, or exposed from environmental disasters. If mothers have a knowingly high body burden from chemical exposures, they are left with no choice other than to discontinue breastfeeding.

Laboratory measurements show breast milk can contain a wide variety of environmental chemicals, including fat soluble persistent organic pollutants such as polychlorinated biphenyls (PCBs), organochlorine pesticides, and polybrominated diphenyl ethers (PBDEs). Phthalates, phenols, metals, and other volatile organic compounds (VOCs) also are detected in addition to several more environmental chemicals. Additional fat- and water soluble-chemicals such as the class of per- and polyfluoroalkylated substances (PFAS) are increasingly found in breast milk due to ubiquitous maternal exposure.

Per- and polyfluoroalkyl substances comprise a large class of synthetic fluorinated chemicals that are extensively used in various consumer and industrial products (1). PFAS are chemically and thermally inert due to the carbon-fluorine bonding, resulting in water, oil, and heat repellency (2). These unique physiochemical properties make them broadly applicable in several products ranging from non-stick cookware, food contact materials, stain- and water-resistant clothing, and firefighting foams. Overall, PFAS exposure is a widespread occurrence, as global manufacturing of PFAS has resulted in their accumulation and persistence in the environment, wildlife, and general population (3, 4). Perfluorooctanoic acid (PFOA) and perfluorooctanesulfonic acid (PFOS), two so-called legacy compounds that have since been phased out of production, are persistent in the environment and human tissues with serum half-lives ranging from 3.8 to 5.4 years, respectively (4).

Dietary intake is a major route of exposure and has been associated with elevated levels of PFAS in serum (5-8). Globally, PFAS has been detected in seafood, fast food, meat, and dairy products (9-11). Milk and dairy products represent a significant exposure pathway for susceptible populations (12, 13). Infants and children are susceptible during early development, experience heavier burdens due to larger exposure to body weight ratio, and may be exposed to PFAS through placental transfer, mouthing behaviors, and breastfeeding (14). Within the United States, three studies have measured and quantified levels of PFAS in breast milk with PFOA and PFOS being the most predominantly detected (15-17). Two of these studies collected breast milk samples in 2004, which was during the time manufacturers began the phase-out of PFOS and PFOA and moved to short-chain alternatives (15, 16). Several epidemiological studies link prenatal and childhood PFAS with adverse effects including immunotoxicity, behavioral changes, and changes in fetal and postnatal growth (18-20).

Adsorption is a well-known remediation strategy for the removal of environmental contaminants. Activated carbon is the most widely used adsorbent for removal of pollutants in industrial processes due to its large surface area, high porosity, and various functional groups (21). Additionally, smectite clay minerals such as montmorillonites are viable adsorbents due to their abundance, low cost, and high exchange capacity (22, 23). These clay minerals are safe for human and animal consumption while having a high binding affinity and capacity for environmental contaminants (24, 25). Montmorillonite clays have been used as dietary additives and are generally recognized as safe (GRAS) by the U.S. FDA. Previous research has demonstrated that the addition of calcium montmorillonite (CM) clays through dietary exposure have been used to adsorb aflatoxin M1 (AFM1) ultimately reducing levels in cow's milk without compromising the nutritional integrity (26, 27). Further, nutrient-amended CM clays have been shown to stably adsorb PFAS from various matrices, including water and soil, ultimately reducing PFAS bioavailability in soil and translocation to plants (28-30).

There are no existing breast milk filtration tech ologies available to consumers. Thus, there are unmet needs in the art for filtration or sorbent technologies to reduce levels of toxic chemicals in breast milk and dairy milk. Particularly, the art is deficient in sorbent filters to remove fat- and water-soluble environmental toxins from breast milk and dairy milk. The present invention fulfills this long-standing need in the art.

### SUMMARY OF THE INVENTION

The present invention is directed to a sorbent formulation, comprising at least one montmorillonite clay.

The present invention is further directed to a filter composite to remove environmental toxins from milk. The filter composite comprises a plurality of layers of the sorbent formulation described herein or a plurality of beads formed therefrom formed as a nanostructure compatible to integrate with a milk pump.

The present invention is directed further to a method for removing at least one environmental toxin from a milk matrix. In this method, the milk is pumped through the filter composite described herein, thereby removing the at least one environmental toxin from the milk matrix.

The present invention is directed further still to a filter for human breast milk. The filter comprises at least one amended montmorillonite clay formulated as a filter composite.

The present invention is directed further still to a method for filtering out per- and polyfluoroalkyl substances from human breast milk during pumping. In the method the filter described herein is integrated in a fluid relationship with a breast pump. The human breast milk flows through the filter during pumping, where the filter comprises a sorbent effective to remove the PFAS therefrom, thereby filtering the human breast milk.

The present invention is directed further still to a filtration system for human breast milk. The filtration system comprises a sorbent clay formulation integrated within a breast milk pump, where the sorbent clay formulation is effective to remove environmental toxins from the breast milk.

Other and further aspects, features, benefits, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 illustrates the QuEChERS extraction and dispersive solid phase extraction (dSPE) clean-up procedure.

FIG. 2 shows the reduction of fat (** p<0.005), protein (** p<0.001), and milk urea nitrogen (MUN) (**** p<0.0001) following filtration of dairy milk through a commercial water pitcher filter. Data is presented as mean±SD, n=3.

FIGS. 3A-3C show the reduction of PFOA (FIG. 3A) and PFOS (FIG. 3B) following addition of activated carbon (AC), calcium montmorillonite (CM), CM-carnitine, and CM-choline, and of PFCAs (FIG. 3C) following addition of CM added at an inclusion rate of 0.2% and shaken for 30 min. Data is presented as mean±SD,n=3.

FIG. 4 shows the nutrient analysis of fat, protein (*p<0.05), lactose, solids-non-fats (SNF), milk urea nitrogen (MUN) following addition of AC, CM, CM-carnitine, and CM-choline at an inclusion rate of 0.2% and shaken for 30 min. Data is presented as mean±SD, n=3.

FIGS. 5A-5D show the reduction of PFOA and PFOS following addition of AC (FIG. 5A), CM (FIG. 5B), CM-carnitine (FIG. 5C), and CM-choline (FIG. 5D) at inclusion rates of 0.05%, 0.1%, 0.2%, 0.5%, and 1% and shaken for 30 min.

FIGS. 6A-6B show the adsorption of PTOA (FIG. 6A) and PFOS (FIG. 6B) onto sorbents added at 0.2% in dairy milk and shaken for 5, 10, 20, 30, 60, and 120 min.

### DETAILED DESCRIPTION OF THE INVENTION

As used herein, the articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention.

As used herein, the term “or” in the claims refers to “and/or” unless explicitly indicated to refer to alternatives only or the alternatives are mutually exclusive, although the disclosure supports a definition that refers to only alternatives and “and/or”.

As used herein, the terms “comprise” and “comprising” are used in the inclusive, open sense, meaning that additional elements may be included.

As used herein, the terms “consists of” and “consisting of” are used in the exclusive, closed sense, meaning that additional elements may not be included.

As used herein, the term “includes” or “including” is used herein to mean “including, but not limited to”. The terms “includes”, “including” and “including but not limited to” are used interchangeably.

As used herein, the term “about” refers to a numeric value, including, for example, whole numbers, fractions, and percentages, whether or not explicitly indicated. The term “about” generally refers to a range of numerical values (e.g., +5-10% of the recited value) that one of ordinary skill in the art would consider equivalent to the recited value (e.g., having the same function or result). In some instances, the term “about” may include numerical values that are rounded to the nearest significant figure.

In one embodiment of the present invention, there is provided a sorbent formulation, comprising at least one montmorillonite clay. In this embodiment, the montmorillonite clay may be an amended montmorillonite clay. Representative examples of the amended montmorillonite clay include but are not limited to a calcium montmorillonite (CM) clay, a calcium montmorillonite-carnitine (CM-carnitine) clay or a calcium montmorillonite-choline (CM-choline) clay.

In another embodiment of the present invention, there is provided a filter composite to remove environmental toxins from milk, comprising a plurality of layers of the sorbent formulation as described supra or a plurality of beads formed therefrom formed as a nanostructure compatible to integrate with a milk pump.

In this embodiment, the environmental toxins may be per- and polyfluoroalkyl substances (PFAS). Representative examples of the PFAS may be perfluorooctanoic acid (PFOA) or perfluorooctanesulfonic acid (PFAS) or a combination thereof. In this embodiment, the milk is human breast milk or dairy milk.

In yet another embodiment of the present invention, there is provided a method for removing at least one environmental toxin from a milk matrix, comprising pumping the milk through the filter composite as described supra, thereby removing the at least one environmental toxin from the milk matrix.

In yet another embodiment of the present invention, there is provided a filter for human breast milk, comprising at least one amended montmorillonite clay formulated as a filter composite.

In this embodiment, the amended montmorillonite clay may be a calcium montmorillonite (CM) clay, a calcium montmorillonite-carnitine (CM-carnitine) clay or a calcium montmorillonite-choline (CM-choline) clay or a combination thereof. Further in this embodiment, the at least one montmorillonite clay may be formulated in the filter composite as a plurality of layers or as a plurality of beads formed therefrom. In addition, the filter may be formulated as a sorbent for at least one environmental toxin in the human breast milk. Representative examples of the environmental toxin may be perfluorooctanoic acid (PFOA) or perfluorooctanesulfonic acid (PFAS) or a combination thereof.

In yet another embodiment of the present invention, there is provided a method for filtering out per- and polyfluoroalkyl substances from human breast milk during pumping, comprising integrating the filter as described supra in a fluid relationship with a breast pump; and flowing the human breast milk through the filter during pumping, the filter comprising a sorbent effective to remove the PFAS therefrom, thereby filtering the human breast milk. In this embodiment, the per- and polyfluoroalkyl substances may be perfluorooctanoic acid (PFOA) or perfluorooctanesulfonic acid (PFAS) or a combination thereof.

In yet another embodiment of the present invention, there is provided a filtration system for human breast milk, comprising a sorbent clay formulation integrated within a breast milk pump; the sorbent clay formulation effective to remove environmental toxins from the breast milk.

In this embodiment, the sorbent clay formulation may be a composite filter comprising at least one amended montmorillonite clay as a plurality of layers or as a plurality of beads formed therefrom. Representative examples of the amended montmorillonite clay may be a calcium montmorillonite (CM) clay, a calcium montmorillonite-carnitine (CM-carnitine) clay or a calcium montmorillonite-choline (CM-choline) clay or a combination thereof. Also in this embodiment, the environmental toxins may be per- and polyfluoroalkyl substances (PFAS). Representative examples of the PFAS may be perfluorooctanoic acid (PFOA) or perfluorooctanesulfonic acid (PFAS) or a combination thereof.

Provided herein are clay based sorbents effective to reduce environmental toxins in milk, for example, human breast milk and bovine milk, particularly dairy produced without substantially affecting the nutritional value thereof. The clay based sorbents may be formulated as filter composites or filters structured or configured to integrate with a milk pump, for example as a filtration system, such that milk flows through the filter composites or filters whereupon the environmental toxins are removed. The filter composites or filters may contain a single type of clay based sorbent for removal of a specific toxin or may contain a combination of clay based sorbents to effectively reduce or remove several classes of toxins. Thus, the present invention also provides methods for removing at least one of these toxins from human breast milk or bovine milk produced by a dairy herd.

The clay based sorbents may contain at least one montmorillonite clay, such as an amended montmorillonite clay. Particularly, an example of an amended montmorillonite clay is a calcium montmorillonite (CM) clay, a calcium montmorillonite-carnitine (CM-carnitine) clay or a calcium montmorillonite-choline (CM-choline) clay.

Examples of environmental toxins are per- and polyfluoroalkyl substances (PFAS), such as, but not limited to, perfluorooctanoic acid (PFOA) and perfluorooctanesulfonic acid (PFOS). It is contemplated that other classes of PFAS toxins may be removed from milk. Non-limiting general examples are short-chain and emerging compounds, branched and linear isomers thereof, fluorotelomer sulfonates (FTS), and sulfonamides (FOSA and FOSAAs).

The following examples are given for the purpose of illustrating various embodiments of the invention and are not meant to limit the present invention in any fashion.

### Example 1

### Materials and Methods

### Reagents and Materials

Native standards of perfluorooctanoic acid (PFOA) and perfluorooctanesulfonic acid (PFOS) were purchased from Sigma-Aldrich (St. Louis, MO). Isotopically labeled internal standards (IS) ¹³C₄-PFOA and ¹³C₄-PFOS were purchased from Wellington Laboratories (Guelph, ON). Calcium montmorillonite (CM) clay was obtained from BASF (Ludwig-shafen, Germany) with a generic formula of (Na,Ca)_{0.3}(Al, Mg)₂Si₄O₁₀(OH)₂·nH₂O and a cation exchange capacity equal to 89.2 cmol/kg (24, 31, 32). Amendments of L-carnitine and choline montmorillonite clays occurred at 100% cation exchange capacity and were previously developed (25, 33-35). Powdered activated carbon (AC) derived from coconut shell, was purchased from General Carbon Corporation (Paterson, NJ). A commercial water pitcher filter was purchased from ZeroWater (Trevose, PA). Lastly, non-homogenized and low-temperature pasteurized cow's milk was purchased from local markets.

### Water Pitcher Filtration

As a worse-case scenario for potential nutrient sorption, cow's milk was filtered through a ZeroWater filter. The remaining filtrate was sent to Texas Dairy Herd Improvement Association to examine impact on nutrients pre- and post-filtration.

### Sample Preparation, Extraction, and Clean-Up Methods

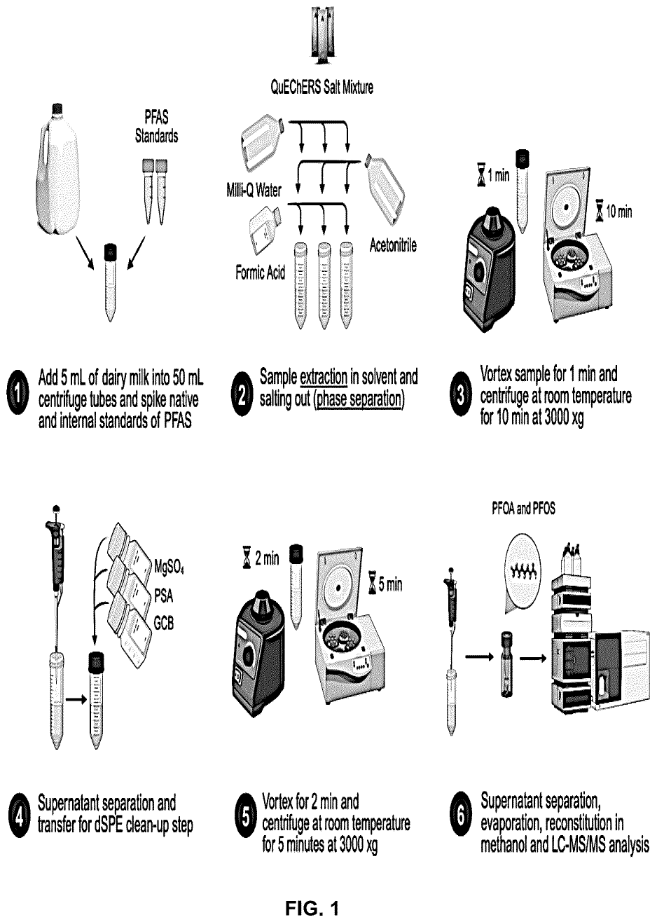

Following a modified U.S. FDA method, extraction and clean-up of PFAS was done by QuEChERS (quick, easy, cheap, effective, rugged, and safe) and dispersive solid phase extraction (dSPE) (FIG. 1). Briefly, 5 mL of cow's milk was added to 50 mL polypropylene tubes followed by the addition of 5 mL of Milli-Q H₂O. Native (2 ng/ml) and internal (0.05 μM) standard solutions of PFOA and PFOS were spiked into dairy milk followed by addition of 10 mL acetonitrile and 150 μl formic acid. Samples were vortexed for 1 min. Next, QuEChERS salt mixture (6000 mg MgSO₄ and 1500 mg NaCl) was added and vigorously shaken to break up agglomerates. Samples were placed on a multi-tube vortexer for an additional 10 min and centrifuged at 3000×g for 5 min. The supernatant was transferred to a 15 mL tube containing the dSPE sorbent mixture (900 mg MgSO₄, 300 mg PSA, and 150 mg graphitized carbon black (GCB)). Samples were vortexed for an additional 2 min and centrifuged at 3000×g for 5 min. The supernatant was transferred to a 60 mL tube and evaporated to near dryness under a gentile stream of nitrogen at 60° C. Sample extracts were reconstituted in 1 mL of methanol, filtered through 0.2 μm nylon filters into polypropylene vials, and quantified on the LC-MS/MS.

### LC-MS/MS Analysis

PFOA and PFOS were analyzed using a Waters Acquity Ultraperformance Liquid Chromatography/tandem mass spectrometer (LC-MS/MS) and the detection method followed Sciex with modifications. An Acquity BEH C18 column (2.1×50 mm, 1.7 μm) was used for separation and kept at 40° C. in the column oven. The gradient program for elution was 10% eluent B (initial), 10%-55% (0 to 0.1 min), 55%-99% (0.1 to 4.5 min), 99% (4.5 to 5 min), and 99%-10% (5 to 6.5 min) carried out at a flow rate of 0.6 mL/min. The injection volume for each sample was 10 μL. The mass spectrometer was used with an electrospray ionization interface (ESI) and operated in a negative ion mode. The capillary voltage was 4.5 V and the source temperature was 450° C. The cone voltage (mV) for PFOA and PFOS was 20 and 40. The monitored precursor and product ions for PFOA and PFOS were: m/z at 413 and 369 (PFOA); 417 and 372 (¹³C-PFOA). 499 and 80 (PFOS); 503 and 80 (¹³C-PFOS). Peak area of PFOA and PFOS at 0.5 min retention time was recorded. A 7-point calibration curve was constructed from 0.1 to 1000 ng/ml in dairy milk and showed good linearity with R²>0.99. The limit of detection was 0.1 ng/ml and the average recovery was 76-94% calculated based on 0.05 μM internal standards. Nitrogen gas was used as the collision and curtain gas, and argon gas was used as the nebulizer and heater gas. Empower analyst software was used to control the LC/MS-MS system and acquire the data.

Comparison of Carbon and Clay Addition of Milk to Evaluate Reduction of PFOA and PFOS with Subsequent Nutrient Analysis

Activated carbon (AC), calcium montmorillonite (CM), CM-carnitine, and CM-choline were weighed and added into 50 mL polypropylene tubes at an inclusion rate of 0.2%, 2 ng/ml of native PFOA and PFOS stock solution was spiked into 40 mL of cow's milk, shaken for 30 min, and centrifuged at 3000×g for 10 min at ambient temperature. Supernatant (35 mL) was transferred to vials with preservative and sent to Texas Dairy Herd Improvement Association (TX DHIA) for nutrient analysis. The remaining aliquot was transferred to a new polypropylene tube, spiked with PFOA and PFOS internal standards, and taken through the QuEChERS and dSPE procedure.

For the dosimetry study, AC, CM, CM-carnitine, and CM choline were added into milk at the following inclusion rates: 0.05%, 0.1%, 0.2%, 0.5%, and 1% and taken through the extraction and clean-up procedure. For the kinetic time course study, AC, CM, CM-carnitine, and CM-choline were added into milk at 0.2% and shaken for 5, 10, 20, 30, 60, and 120 min followed by extraction and clean-up procedure prior to LC-MS/MS analysis.

### Statistical Analysis

GraphPad Prism was used for statistical analyses. An unpaired t-test was used to determine statistical significance of each nutritional component following filtration using a commercial water filter. Reduction of PFOA and PFOS was analyzed using one-way ANOVA and Tukey's Test post-hoc analysis to compare means of each treatment group. Lastly, nutrient analysis following the addition of carbon and clay-based sorbents was analyzed using one-way ANOVA.

### Example 2

### Water Pitcher Filtration

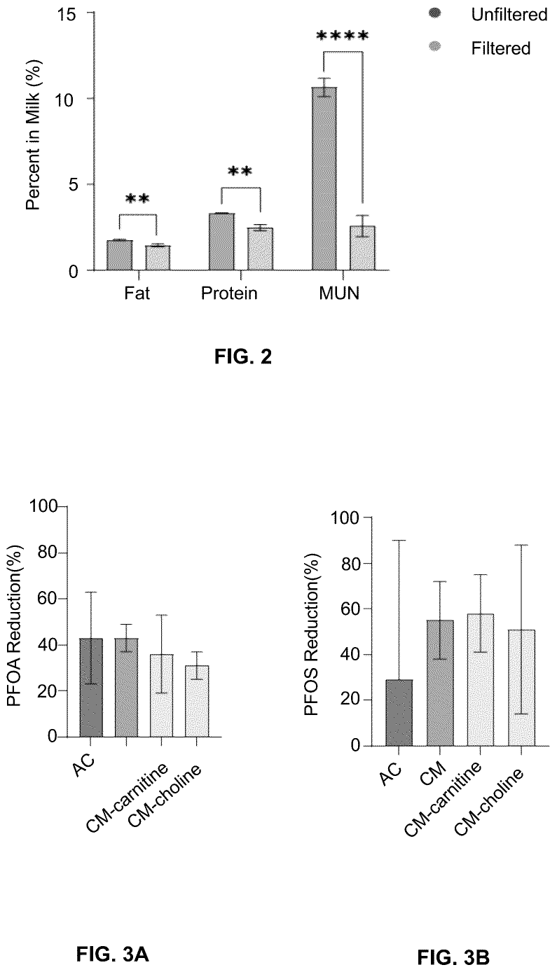

Cow's milk was filtered through a ZeroWater pitcher, which is NSF certified to remove chemical contaminants from water. Percent fat, protein, and milk urea nitrogen (MUN) were all significantly reduced after filtration (FIG. 2).

### PFOA and PFOS Reduction in Cow's Milk Following Addition of Carbon and Clays

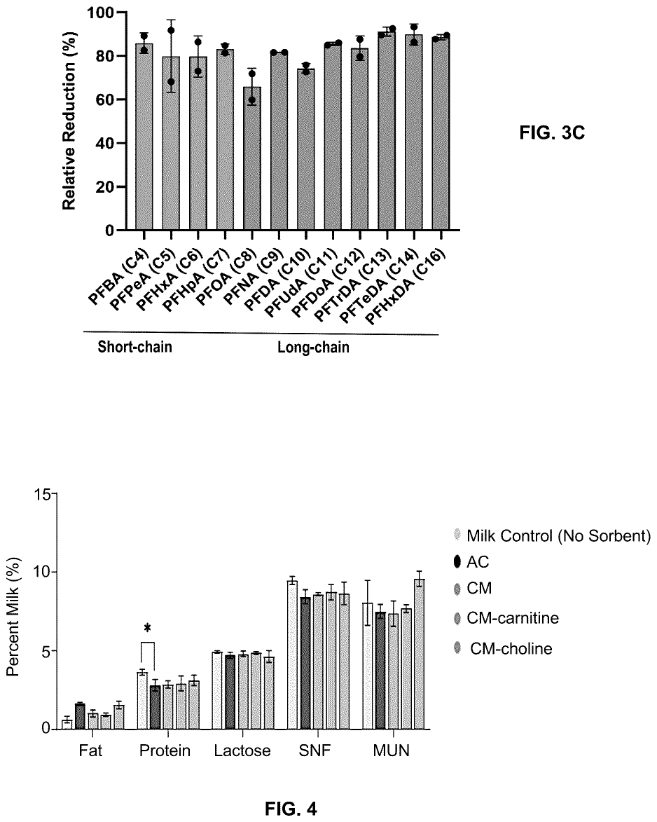

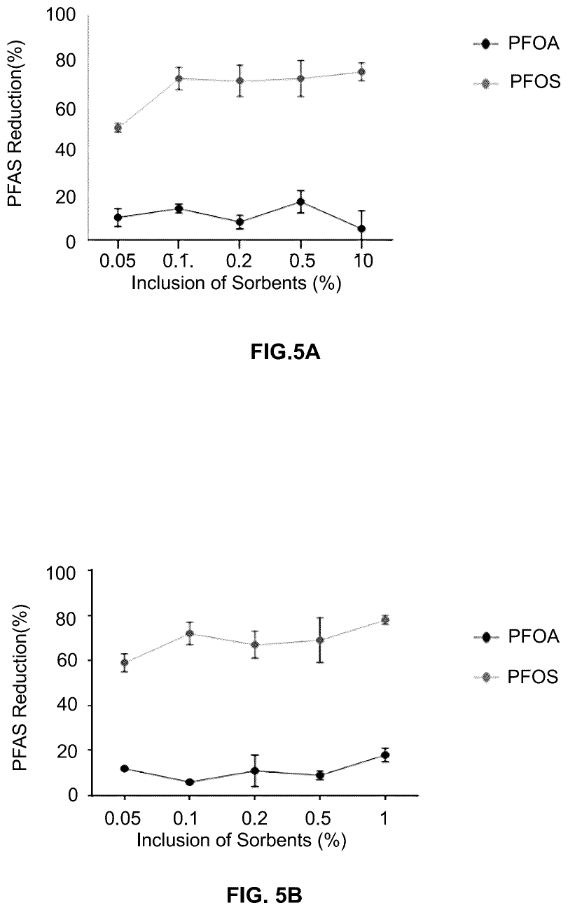

The addition of parent and amended clays reduced PFOA, PFOS and PFCAs levels in cow's milk (FIGS. 3A-3C). In FIGS. 3A-3B on average, parent CM reduced PFOA and PFOS by 43% and 55%, respectively. The addition of CM-carnitine reduced PFOA and PFOS by 36% and 58%. The addition of CM-choline reduced PFOA and PFOS by 51% and 31%. Reduction of PFOA and PFOS was variable for activated carbon which showed the least amount of reduction at 32% and 29%, respectively. In FIG. 3C parent CM reduced short-chain (C4-C7) PFCAs about 79% to about 83% and long-chain (C8-C16) PFCAs about 63% to about 90%. The addition of clay sorbents did not impact milk fat, protein, solids-non-fats, milk urea nitrogen, or lactose (FIG. 4). However, activated carbon significantly reduced protein levels.

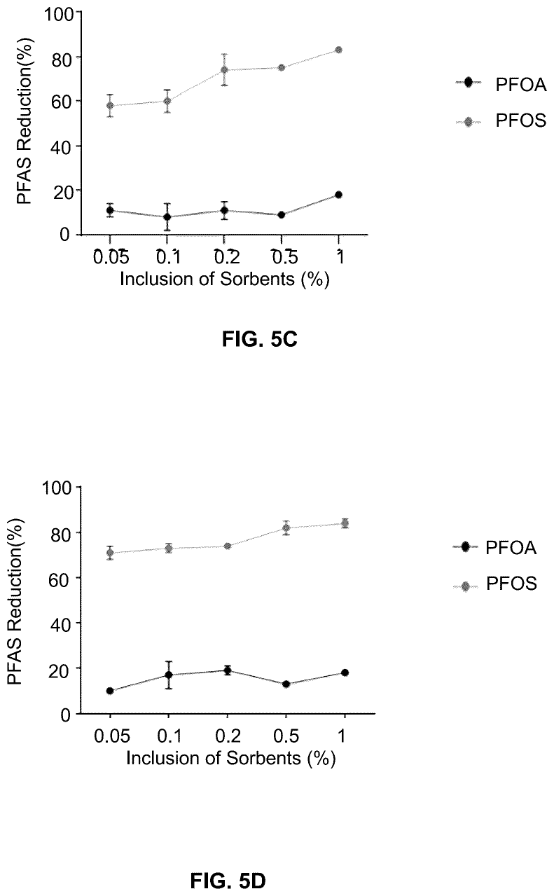

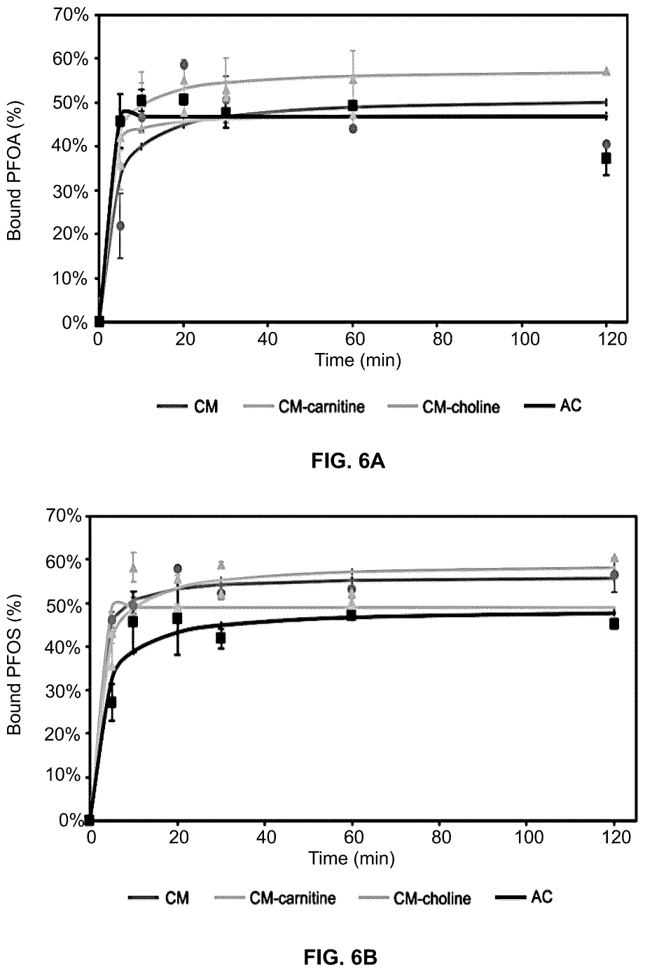

For the dosimetry study, reduction of PFOA was similar at all sorbent inclusion rates, but a dose-dependency for PFOS was observed (FIGS. 5A-5D). The reduction of PFOA was lowered than that of PFOS for all sorbent treatments. For the time course study, PFOA and PFOS rapidly reached sorption equilibrium within 10 min (FIGS. 6A-6B). Based on the correlation coefficient values (R²) and comparison between the experimental binding capacities and calculated binding capacities, adsorption of PFOA and PFOS onto sorbents best fits the pseudo-second-order kinetic model. Qe (exp) represents the maximum binding from experiment, Qe (cal) represents the maximum binding from the model, and K₂ represents the adsorption rate constant. The reduction of PFOA and PFOS remained for 120 min following equilibrium at 40.7% and 56.5% for CM, 57.2% and 46% for CM-carnitine, 37.5% and 60.5% for CM-choline, and 37.2% and 45.3% for activated carbon respectively.

### Example 3

### Clay-Based Filtration to Reduce PFAS in Bovine Milk

For all milk samples, 2 ppb of native PFOA and PFOS solution and their corresponding internal standard are spiked into cow's milk. To determine starting sorbents, an initial screening of various types of clays are tested for sorption capability. These sorbents are CM, CM-carnitine, CM-choline, and powdered activated carbon (PAC) as a comparison. For the dosimetry study, sorbents are added into spiked cow's milk at inclusion rates ranging from 0.05 to 1% to determine an optimal inclusion rate. Binding efficiency is compared at different time intervals (5 min to 30 min).

Extraction of PFAS is carried out using QuEChERS and dSPE and analyzed via LC-MS/MS both as described in Example 1. To examine impact on nutrients, an aliquot of samples are sent to the Texas Dairy Herd Improvement Association (TX DHIA) for analysis. The dSPE mixture used during cleanup contains graphitized carbon black (GCB) which has the potential to bind PFAS. While it is good at removing polar interferences, it should spend as little contact time with the sample as possible. If binding efficiency is affected, a C18 adsorbent can replace GCB.

It is anticipated that these sorbents are effective to reduce PFOA and PFOS in bovine milk with a binding efficiency of about 5 minutes. CM-carnitine was the best binder for PFOA and CM-choline was the best binder for PFOS. It is contemplated to add a mixture of both sorbents to determine if they bind PFOA and PFOS at the same efficiency in the mixture.

### Example 4

### Clay-Based Filtration to Reduce PFAS in Human Breast Milk

Breast milk samples (n=90) are tested for PFAS reduction. The sorbents testes are CM, CM-carnitine, CM-choline, and powdered activated carbon (PAC) as a comparison. These sorbents are added into spiked breast milk samples at inclusion rates from about 0.05 to about 1%. Binding efficiency also is compared at different time intervals of 5 min to 30 min. As with bovine milk in Example 3, extraction of PFAS is carried out using QUEChERS and dSPE and analyzed via LC-MS/MS both as described in Example 1.

To examine the impact on nutrients, the breast milk samples are analyzed for levels of fats, carbohydrates, and protein pre- and post-filtration via the Miris human milk analyzer. This device is certified as an in vitro diagnostic medical device and is commonly used in the neonatal intensive care unit and in donor milk banks. Alternatively, if the Miris human milk analyzer is not available, analytical techniques such as HPLC-MS or LC-MS may be used. Additionally, native PFAS solutions may be spiked in if levels are low or unable to be detected in human breast milk.

### Discussion

Multiple methods of treatment and purification of PFAS have been developed and reported in literature for contaminated drinking water including conventional sorbents such as ion exchange resins and various types of activated carbons. Carbonaceous materials such as granular and powdered activated carbon are widely studied for the removal of long-chain PFAS in water as they readily sorb through hydrophobic interactions (36). In our study, reduction of PFOA and PFOS by activated carbon was comparable to parent and amended clay sorbents although it was variable. They are also commonly used in commercial water filters in combination with anion exchange resins to effectively reduce up to 99% of PFOA and PFOS (23). However, milk is a complex biological matrix, and as demonstrated in FIG. 2, current technologies developed are not feasible for removing PFAS in milk without impacting the nutritional composition.

PFAS levels in dairy and breast milk are usually detected at levels in the range of pg/mL to ng/ml. The mitigation study design was based on the highest measured concentrations detected in breast milk which was 1.85 ng/ml (17). Thus, for all clay treatment studies, 2 ng/ml of PFOA and PFOS were spiked into dairy milk samples to evaluate if sorbents would be able to reduce a high concentration level in this type of matrix. In the dosimetry study, adsorption of PFOS was always higher than PFOA which could be the result of competitive effects (25, 37, 38). One would expect dose-dependency as the inclusion rate (%) of sorbents increases. Because of adsorption of PFOS is favored than PFOA, adsorption of PFOS is dose-dependent that it increased with higher sorbent inclusion rates (0.05% to 1%). The less competitive nature of PFOA explained the stable sorption of PFOA in a PFAS mixture at different sorbent inclusion rates.

Sorption kinetics followed a pseudo second-order kinetic model which is consistent with previous studies that have examined the binding of PFAS to different types of clay minerals (39). This pseudo second-order model suggested that the sorption involves chemisorption and that the adsorption rate is dependent on the adsorption capacity. Additionally, adsorption of both PFOA and PFOS reached equilibrium within 5 min of contact, suggesting high sensitivity and affinity. The saturated plateau with low desorption suggested that the binding was tight for up to 120 min and saturable binding sites on sorbent surfaces.

There are several factors that may influence the binding interaction between PFAS and clay minerals. The binding of PFOA and PFOS onto parent and amended montmorillonite clays is likely driven by hydrophobic interactions between the perfluorocarbon chain tail and electrostatic interactions between the functional head groups. In this study, PFOS had higher percent reduction than PFOA following addition of both parent and amended clays. Perfluorinated sulfonates (PFSAs) typically have higher sorption than perfluorinated carboxylic acids (PFCAs) due to the hydrophobicity of sulfonates in comparison to carboxylates (39, 40). Additionally, CM-carnitine and CM-choline are modified clay minerals that contain ammonium quaternary groups and have higher PFAS removal capacity (28). However, binding of PFOA and PFOS to amended clays was comparable to parent CM, suggesting parent CM as a highly effective and economical friendly sorbent for PFAS in milk. Although the amendments had limited contribution to PFAS sorption, the study on the slow release of nutrients from parent clays is warranted to investigate the possible add-on nutrient value of including nutrient-amended clays. The pH of the matrix is an important factor that may influence adsorption as it can change the charge of both the functional head group and clay mineral surface. PFOA and PFOS are anionic in milk and sorption of anionic PFAS tends to increase with decreasing pH.

The following referenced are cited herein:
1. Panieri, et al. PFAS Molecules: A Major Concern for the Human Health and the Environment. Toxics, 10(2):44, 2022.
2. Brase, et al. Legacy and Emerging Per- and Polyfluoroalkyl Substances: Analytical Techniques, Environmental Fate, and Health Effects. International journal of molecular sciences, 22(3):995, 2021.
3. De Silva, et al. PFAS Exposure Pathways for Humans and Wildlife: A Synthesis of Current Knowledge and Key Gaps in Understanding. Environmental toxicology and chemistry, 40(3):631-657, 2021.
4. Sunderland, et al. A review of the pathways of human exposure to poly- and perfluoroalkyl substances (PFASs) and present understanding of health effects. Journal of exposure science & environmental epidemiology, 29(2): 131-147, 2019.
5. Stahl, et al. Perfluorinated compounds in fish from U.S. urban rivers and the Great Lakes. The Science of the total environment, 499:185-195, 2014.
6. Christensen, et al. Perfluoroalkyl substances and fish consumption. Environmental research, 154:145-151, 2017.
7. Roth, et al. Diet as an Exposure Source and Mediator of Per- and Polyfluoroalkyl Substance (PFAS) Toxicity. Frontiers in toxicology, 2:601149, 2020.
8. Seshasayee, et al. Dietary patterns and PFAS plasma concentrations in childhood: Project Viva, USA. Environment international, 151:106415, 2021.
9. Susmann, et al. Dietary Habits Related to Food Packaging and Population Exposure to PFASs. Environmental health perspectives, 127(10):107003, 2019.
10. Mikołajczyk, et al. Occurrence of perfluoroalkyl substances in cow's, goat's and sheep's milk-dietary intake and risk assessment. Journal of veterinary research, 67(4):593-602, 2023.
11. Xiao et al. Carry-over rate of per- and polyfluoroalkyl substances to raw milk and human exposure risks in different regions of China. The Science of the total environment, 944:173902, 2024.
12. Vestergren, et al. Bioaccumulation of perfluoroalkyl acids in dairy cows in a naturally contaminated environment. Environmental science and pollution research international, 20(11), 7959-7969, 2013.
13. Macheka, et al. Determination and assessment of human dietary intake of per and polyfluoroalkyl substances in retail dairy milk and infant formula from South Africa The Science of the total environment, 755(Pt 2):142697, 2021.
14. Liew, et al. Developmental Exposures to Perfluoroalkyl Substances (PFASs): An Update of Associated Health Outcomes. Current environmental health reports, 5(1):1-19, 2018.
15. Tao, et al. Perfluorinated compounds in human milk from Massachusetts, U.S.A. Environmental science & technology, 42(8), 3096-3101, 2008.
16. von Ehrenstein, et al. Polyfluoroalkyl chemicals in the serum and milk of breastfeeding women. Reproductive toxicology (Elmsford, N.Y.), 27(3-4), 239-245, 2009.
17. Zheng, et al. Per- and Polyfluoroalkyl Substances (PFAS) in Breast Milk: Concerning Trends for Current-Use PFAS. Environmental science & technology, 55(11):7510-7520, 2021.
18. Grandjean, et al. Serum vaccine antibody concentrations in children exposed to perfluorinated compounds. JAMA, 307(4):391-397, 2012.
19. Rappazzo, et al. Exposure to Perfluorinated Alkyl Substances and Health Outcomes in Children: A Systematic Review of the Epidemiologic Literature. International journal of environmental research and public health, 14(7), 691, 2017.
20. Harris, et al. Prenatal and childhood exposure to per- and polyfluoroalkyl substances (PFAS) and child executive function and behavioral problems. Environmental research, 202:111621, 2021.
21. Gill, et al. Remediation of environmental toxicants using carbonaceous materials: opportunity and challenges. Environmental science and pollution research international, 30(27):69727-69750, 2023.
22. Phillips, et al. Characterization of clay-based enterosorbents for the prevention of aflatoxicosis. Advances in experimental medicine and biology, 504:157-171, 2002.
23. Mukhopadhyay, et al. Natural and engineered clays and clay minerals for the removal of poly- and perfluoroalkyl substances from water: State-of-the-art and future perspectives. Advances in colloid and interface science, 297:102537, 2021.
24. Phillips, et al. NovaSil clay for the protection of humans and animals from aflatoxins and other contaminants. Clays and clay minerals, 67(1):99-110, 2019.
25. Wang, et al. Enhanced adsorption of per- and polyfluoroalkyl substances (PFAS) by edible, nutrient-amended montmorillonite clays. Water research, 188:116534, 2021.
26. Harvey, et al. Effects on aflatoxin M1 residues in milk by addition of hydrated sodium calcium aluminosilicate to aflatoxin-contaminated diets of dairy cows. American journal of veterinary research, 52(9):1556-1559, 1991.
27. Maki, et al. Effects of calcium montmorillonite clay and aflatoxin exposure on dry matter intake, milk production, and milk composition. Journal of dairy science, 99(2):1039-1046, 2016.
28. Hearon, et al. Montmorillonite clay-based sorbents decrease the bioavailability of per- and polyfluoroalkyl substances (PFAS) from soil and their translocation to plants. Environmental research, 205:112433, 2022.
29. Wang, et al. In vitro and in vivo remediation of per- and polyfluoroalkyl substances by processed and amended clays and activated carbon in soil. Applied soil ecology: a section of Agriculture, Ecosystems & Environment, 196:105285, 2024.
30. Zhou, et al. A novel montmorillonite clay-cetylpyridinium chloride material for reducing PFAS leachability and bioavailability from soils. Journal of hazardous materials, 465:133402, 2024.
31. Grant, P. G., & Phillips, T. D. Isothermal Adsorption of Aflatoxin B(1) on HSCAS Clay. Journal of agricultural and food chemistry, 46(2):599-605, 1998.
32. Wang, et al. A high capacity bentonite clay for the sorption of aflatoxins. Food additives & contaminants. Part A, Chemistry, analysis, control, exposure & risk assessment, 37(2):332-341, 2020.
33. Rivenbark, et al. Development and characterization of chlorophyll-amended montmorillonite clays for the adsorption and detoxification of benzene. Water research, 221, 118788, 2022.
34. Wang, et al. Development of enterosorbents that can be added to food and water to reduce toxin exposures during disasters. Journal of environmental science and health. Part. B, Pesticides, food contaminants, and agricultural wastes, 54(6):514-524, 2019.
35. Wang, M., & Phillips, T. D. Lecithin-amended montmorillonite clays enhance the antibacterial effect of barrier creams. Colloids and surfaces. B, Biointerfaces, 229:113450, 2023.
36. Nakazawa, et al. Maximum desorption of perfluoroalkyl substances adsorbed on granular activated carbon used in full-scale drinking water treatment plants. Water research, 254:121396, 2024.
37. Zhang, et al. Adsorption of perfluorooctanoic acid (PFOA) and perfluorooctanesulfonic acid (PFOS) by aluminum-based drinking water treatment residuals. Journal of Hazardous Materials Letters, 2:100034, 2021.
38. Fang, et al. Selective perfluorooctanoic acid (PFOA) and perfluorooctane sulfonate (PFOS) adsorption by nanoscale zero-valent iron (nZVI): performance and mechanisms. Environmental Science: Nano, 11(5):1915-1925, 2024.
39. Zhao, et al. Comparison of the sorption behaviors and mechanisms of perfluorosulfonates and perfluorocarboxylic acids on three kinds of clay minerals. Chemosphere, 114:51-58, 2014.
40. Higgins, C. P., & Luthy, R. G. Sorption of perfluorinated surfactants on sediments. Environmental science & technology, 40(23):7251-7256, 2006.

What is claimed is:

1. A sorbent formulation, comprising at least one montmorillonite clay.

2. The sorbent formulation of claim 1, wherein the montmorillonite clay is an amended montmorillonite clay.

3. The sorbent formulation of claim 2, wherein the amended montmorillonite clay is a calcium montmorillonite (CM) clay, a calcium montmorillonite-carnitine (CM-carnitine) clay or a calcium montmorillonite-choline (CM-choline) clay.

4. A filter composite to remove environmental toxins from milk, comprising:
a plurality of layers of the sorbent formulation of claim 1 or a plurality of beads formed therefrom formed as a nanostructure compatible to integrate with a milk pump.

5. The filter composite of claim 4, wherein the environmental toxins are per- and polyfluoroalkyl substances (PFAS).

6. The filter composite of claim 5, wherein the PFAS is perfluorooctanoic acid (PFOA) or perfluorooctanesulfonic acid (PFAS) or a combination thereof.

7. The filter composite of claim 4, wherein the milk is human breast milk or dairy milk.

8. A method for removing at least one environmental toxin from a milk matrix, comprising:
pumping the milk through the filter composite of claim 4, thereby removing the at least one environmental toxin from the milk matrix.

9. A filter for human breast milk, comprising:
at least one amended montmorillonite clay formulated as a filter composite.

10. The filter of claim 9, wherein the amended montmorillonite clay is a calcium montmorillonite (CM) clay, a calcium montmorillonite-carnitine (CM-carnitine) clay or a calcium montmorillonite-choline (CM-choline) clay or a combination thereof.

11. The filter of claim 9, wherein the at least one montmorillonite clay is formulated in the filter composite as a plurality of layers or as a plurality of beads formed therefrom.

12. The filter of claim 9, wherein the filter is formulated as a sorbent for at least one environmental toxin in the human breast milk.

13. The filter of claim 12, wherein the environmental toxin is perfluorooctanoic acid (PFOA) or perfluorooctanesulfonic acid (PFAS) or a combination thereof.

14. A method for filtering out per- and polyfluoroalkyl substances from human breast milk during pumping, comprising:
integrating the filter of claim 9 in a fluid relationship with a breast pump; and
flowing the human breast milk through the filter during pumping, said filter comprising a sorbent effective to remove the PFAS therefrom, thereby filtering the human breast milk.

15. The method of claim 14, wherein the per- and polyfluoroalkyl substances are perfluorooctanoic acid (PFOA) or perfluorooctanesulfonic acid (PFAS) or a combination thereof.

16. A filtration system for human breast milk, comprising a sorbent clay formulation integrated within a breast milk pump; said sorbent clay formulation effective to remove environmental toxins from the breast milk.

17. The filtration system of claim 16, wherein the sorbent clay formulation is a composite filter comprising at least one amended montmorillonite clay as a plurality of layers or as a plurality of beads formed therefrom.

18. The filtration system of claim 17, wherein the amended montmorillonite clay is a calcium montmorillonite (CM) clay, a calcium montmorillonite-carnitine (CM-carnitine) clay or a calcium montmorillonite-choline (CM-choline) clay or a combination thereof.

19. The filtration system of claim 16, wherein the environmental toxins are per- and polyfluoroalkyl substances (PFAS).

20. The filtration system of claim 19, wherein the PFAS is perfluorooctanoic acid (PFOA) or perfluorooctanesulfonic acid (PFAS) or a combination thereof.
